(19) United States
(12) Patent Application Publication
(10) Pub. No.: US 2002/0043059 A1
(43) Pub. Date: Apr. 18, 2002

(54) Single row or plant combine harvesting machine

(76) Inventors: Calvin F. Konzak, Pullman, WA (US); Michael A. Davis, Pullman, WA (US)

Correspondence Address: WELLS ST. JOHN P.S., 601 W. FIRST, SUITE 1300, SPOKANE, WA, 99201-3828, US

(21) Appl. No.: 09/941,216

(22) Filed: Aug. 27, 2001

Related U.S. Application Data
(63) Continuation of application No. 09/134,018, filed on Aug. 14, 1998, now abandoned.

(51) Int. Cl. A01D 34/02

(52) U.S. Cl. 56/12.8; 56/16.5

(57) ABSTRACT

A single row or single plant harvesting machine which is particularly useful for harvesting test and developmental plots used by plant breeders of cereal grains. The harvester has a cutting head with cutter that severs the stalks of the grain plants and produces cuttings. The cuttings are threshed by an impeller to free the grain, seeds or other plant product. The impeller is also used to generate a vacuum which draws the cuttings into an intake port which feed the thresher. The impeller further conveys the threshed cuttings to a separator which separates the grain seeds from the straw and chaff which are discharged onto the ground. The harvester can be carried on a human operator or be rolled using a wheeled carriage. The harvester eliminates bundling and remote threshing while also speeding and simplifying the harvesting of small test and developmental plots.

### TECHNICAL FIELD

The field of this invention is single row or single plant harvesting machines used by plant breeders to harvest, thresh and separate seeds of cereal grains and other crop plants.

### BACKGROUND OF THE INVENTION

Breeders of plants routinely manage experimental or developmental plots wherein new or experimental plant varieties are grown. These plots are relatively small in scale as compared to regular agricultural field production. The test plots contain plants which are typically arranged in rows. The rows frequently range in length from 1-25 feet. In some cases the plant breeder also utilizes a single plant or group of plants during the earlier stages of development. Thereafter the breeder typically advances from single plants or small groups of plants up to having a small row of plants under development. At further stages, the breeder may use small or test plots which most typically includes a number of rows having the same variety. It is also common for a particular type or variety of plant to be grown in a single row of a test plot. Such test plots often include multiple varieties which are preferably kept separate for reasons of experimental and developmental control. Such test plots can be used in connection with the cultivation of most crops, but are especially important in the development of improved varieties of commercially significant crops such as wheat, barley, rice, oats, other cereal grains, and other types of seed bearing plants.

Previously, these small scale test or experimental plots or single plants have been harvested by hand. This is a relatively time consuming activity which has significant labor costs. It is also back-breaking work that is frequently unpleasant and usually performed in hot weather. Hand harvesting also typically involves using a sickle, scythe or similar tools which are sharp and pose a risk of harm to the harvest workers. It is often difficult to find labor willing to undertake this hand harvesting process. This problem is exacerbated by competition from commercial farming operations which can pay more and offer more pleasant working conditions.

Harvesting of test plots is usually performed in a manner that harvests only a single plant or single row at a time. Some of the prior art harvesting equipment has been constructed for harvesting multiple rows. These harvesters work as small field harvesters. Although such harvesters have proven satisfactory for these relatively large developmental plots sown with a single variety with numerous adjacent rows, they have not been suitable for harvesting smaller plots. These smaller test or increase plots have single plants, single rows, or a small number of relatively small rows. Such small plots cannot be successfully harvested using such multi-row harvesters. Use of multiple row harvesters is unacceptable because adjacent rows may be seeded with different varieties. Alternatively, it has been impractical to devote a large swath of field to a single row so that a field harvester can cut a single row standing out alone.

The multi-row harvesters are also impractical or impossible because the small amounts of harvested grain can easily be lost in such machines and the breeder's efforts are lost. Additionally, the larger scale machines have an increased risk of mixing seeds from different varieties because there are more machine parts and larger surfaces where the seeds can be lodged and then subsequently come out along with seeds of a different variety. These considerations have made it only practical to harvest the small plots using hand harvesting.

Harvesting of single plants, small test plots and small developmental plots in a separate or segregated fashion is advantageous because it minimizes the risk that seeds of different varieties may become mixed. Similarly, it is preferred so that seeds from other plants are not erroneously gathered in with the select seeds being sought. This is a particular problem in research fields where many types of plant varieties are being grown and tested.

Prior methods for harvesting and threshing plants or test plots have also typically required separate steps for cutting and threshing. The established methods employ field workers who cut the grain or other crop at the stems by hand using sickles. The field workers then tie the cut plants, complete with stems attached, into bundles. The bundles of plants are then transported to a remotely located threshing machine. At the remote location, the bundles are unloaded and await threshing with numerous other bundles of plants grown from different varieties. To keep the plant varieties completely separate requires very careful labeling and handling of each bundle. The process of transporting the bundles from field to thresher location can also lead to mixing of seeds from different varieties. There are also problems with the bundles from different varieties being mislabeled or the labels becoming lost.

These prior art techniques also have typically employed relatively expensive threshing machines which are only practical if they are used to thresh numerous plots containing different varieties of crops. Since the plant breeder is keenly interested in keeping the varieties separate from one another, it is wisest to clean the threshing machine between runs of different seed varieties. If this is not done, then there will be possible carry-over from one batch to another with derogatory effects on the plant breeder's efforts to maintain strict homogeneity in the breeding program.

At the threshing machine, the crop passes through the threshing machine to separate the seeds or grain from the stems and chaff. The stems and chaff must then be disposed of and the seeds are stored in a suitable manner depending upon the intended use. The prior methods involve multiple steps which are performed at multiple locations. This requires transport of stems and chaff which are not wanted. The prior art techniques also cause a disposal problem since the stems and chaff must now be handled and removed for disposal from the thresher location after the threshing has been completed.

Prior art methods for harvesting test plots have also suffered from difficulties arising from adulteration of the harvested seeds. This frequently occurs when the threshing is performed, as explained above. Such adulteration can also occur when stems of different varieties are accidentally or even intentionally tied together into a bundle for transport purposes. In other situations, the seeds from crops which were earlier threshed can be erroneously mixed with seeds of a different variety. This risk is exacerbated by performing separate cutting and threshing operations at different locations.

It should also be appreciated that any effort to improve harvesting of relatively dry plants such as cereal grains at harvest, must consider the risk of fire. It is desirable to utilize harvesting techniques which minimize the risk that an entire breeding program could go up in smoke if harvesting is done in a way which risks fire. Accordingly, there is a need for improved harvesting of test plots which also minimizes the risk of loss due to fire.

Still further it is sometimes the case that different individual plants, plant groups, or varieties will ripen at different times. Being able to efficiently harvest these plants on a small scale provides greater flexibility and allows the plant breeder to pick optimum conditions for harvest.

There has long been a need for an automated harvesting and threshing machine which is capable of harvesting a single plant, single row or other small test or developmental plant plot. There has also been a long-felt need for such a harvester which allows the grain or other crop seeds to be harvested without hauling unneeded stem and chaff materials. These and other desirable aspects of the invention are described herein.

### BRIEF DESCRIPTION OF THE DRAWINGS

Preferred embodiments of the invention are described below with reference to the following accompanying drawings.

FIG. 1 is a perspective view showing a first embodiment harvester made in accordance with this invention shown in operation by a human operator.

FIG. 2 is a perspective view of the harvester of FIG. 1 shown in isolation without the human operator.

FIG. 3 is a side sectional view showing the harvester of FIG. 1.

FIG. 4 is an enlarged perspective view of a preferred discharge valve used as part of the harvester of FIG. 1.

FIG. 5 is a perspective view of the front part of the harvester shown in FIG. 1. Portions have been removed to show internal components.

FIG. 6 is a view similar to FIG. 5 of a second embodiment using an alternative cutting head construction according to the invention.

FIG. 7 is a perspective showing a third embodiment showing an alternative cutting head portion according to the invention.

FIG. 8 is side elevational view of a fourth alternative embodiment of harvester according to the invention.

FIG. 9 is a perspective view showing the front part of a fifth embodiment of harvester according to the invention.

FIG. 10 is a side elevational view showing the fifth embodiment harvester of FIG. 9 with both the front and rear parts shown. Portions have been broken away and shown in section to better illustrate internal features.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

First Embodiment Generally

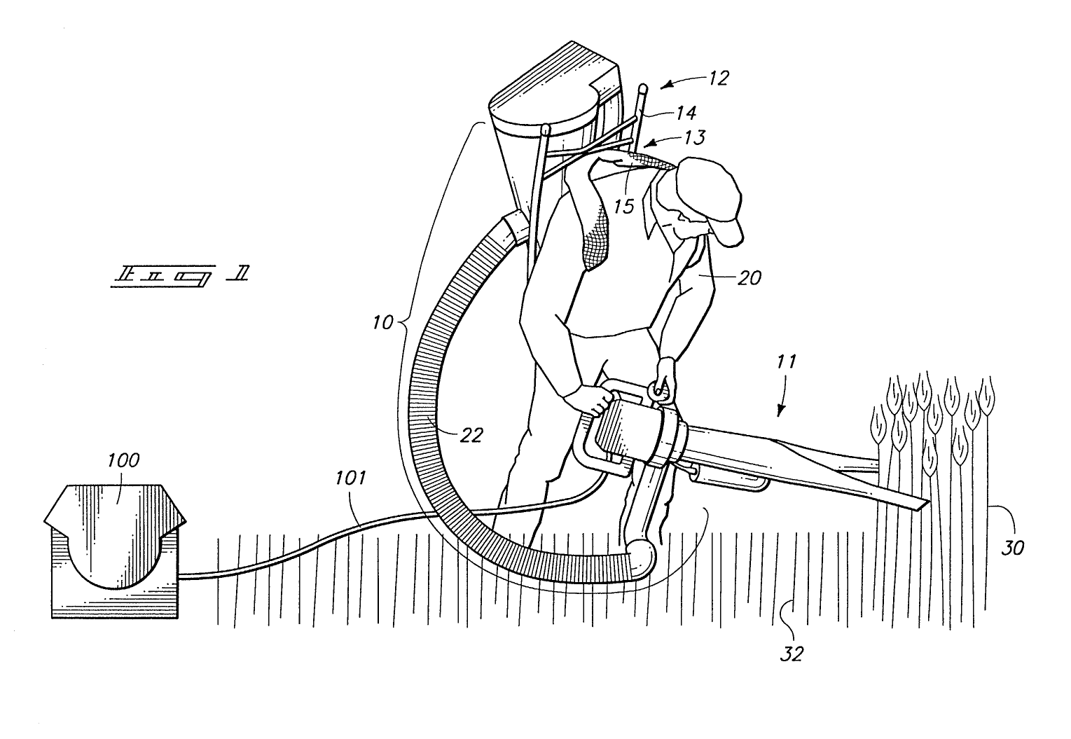

FIG. 1 shows one preferred form of harvester 10 according to the invention. Harvester 10 includes first or front part 11 which is advantageously hand-held by a human operator 20. Human operator 20 also carries a second or rear part 12. The rear part 12 is advantageously adapted for being carried upon the back of the operator. This is preferably done using a pack 13 which can be of various constructions. As shown, pack 13 is in the form of a backpack which includes a pack frame 14 and shoulder straps 15.

FIG. 1 also shows that the front part 11 of the harvester is connected to the rear part 12 by a cuttings conveyor conduit 22 which will be explained in greater detail after first considering the construction of the front and rear parts in greater detail.

FIG. 1 also shows a generator 100 which is preferably a gasoline powered portable generator of common construction and widely used for various power generation purposes. Generator 100 is provided with a highly effective spark suppressing exhaust outflow to minimize the risk of fire. Generator 100 is connected by a power cord 101 to the front part of the harvester. The generator and harvester 10 form a harvesting system which is convenient to use and relatively safe for harvesting cereal grain crops which are highly susceptible to damage from fire.

First Embodiment Front Part

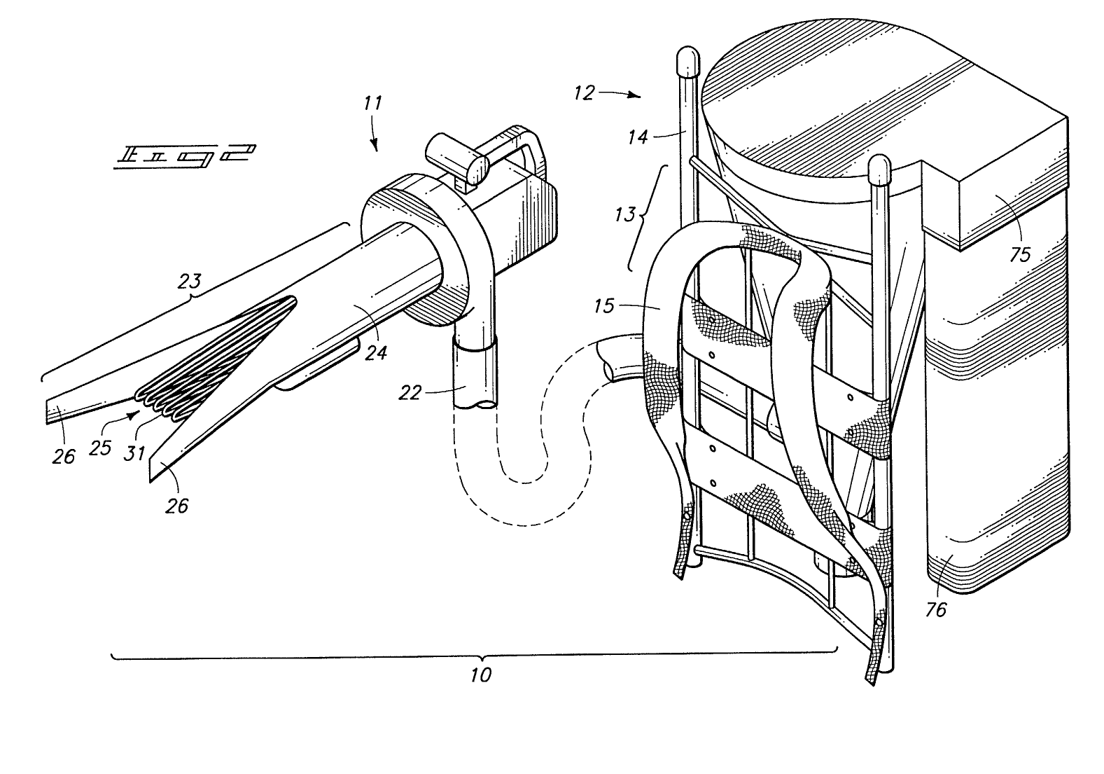

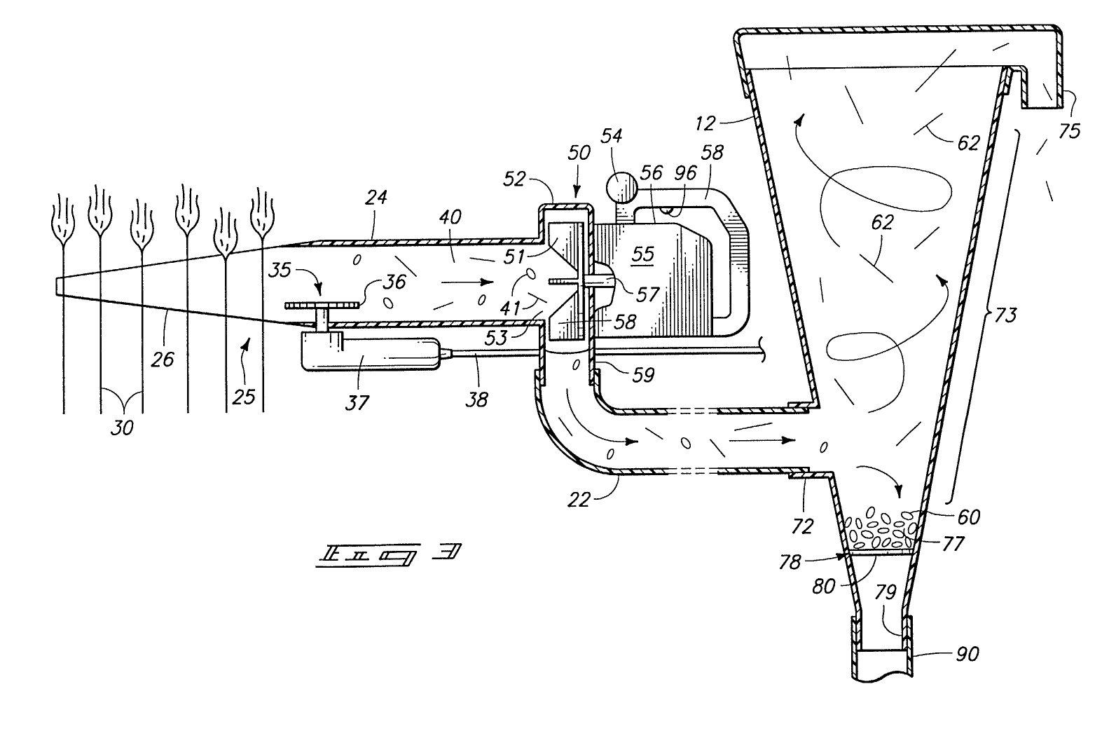

The reader's attention should now be directed to FIGS. 2 and 3 which more fully illustrate the various components used in the preferred construction of harvester 10. FIG. 2 shows that the front part 11 advantageously includes a cutting head 23 which has a cutting head housing 24. The cutting head housing includes a feed opening 25. Guides are preferably included to aid in the feeding of plants into the cutting head 23. The outer guides are along outside edges to focus the crop into the cutting head, and are also important to provide increased safety for the operator by preventing contact with the cutter. The preferred guides can include side guides 26 which extend along the lateral sides of the cutting head outwardly and forwardly of the feed opening 25. The front part 11 can also advantageously include cutter guides 31 which aid in directing and supporting the plants during the cutting operation.

FIG. 3 is a sectional diagram showing key components of the harvester 10. This FIG. shows the side guides 26 directing wheat plants 30 into the feed opening 25. A cutter 35 is mounted on the cutting head, preferably within the feed opening. As shown, cutter 35 includes a rotary cutting wheel or blade 36 similar to a circular saw blade. Cutter 35 also includes a cutter motor 37 which is used to rotate the cutter blade. Motor 37 is advantageously an electrical motor which includes a right angle gear set as part of the motor output drive. Motor 37 is connected by a cutter motor drive electrical cord 38 which extends to other parts of the front part of the harvester as shown in FIG. 3. Other types of cutters and cutter drivers can be used in lieu of the circular blade 36, electrical motor 37 and enclosed gear set shown. Some alternative configurations are shown and described elsewhere herein.

The cutter 35 severs the plants 30 producing cuttings 41 which are severed from remains 32 (see FIG. 1) which remain in the field.

FIG. 3 does not illustrate the cutting guides 31 shown in FIG. 2 in order to simplify the sectional illustration. However, guides 31 are connected to the cutting head housing and extend outwardly and forwardly over and under the cutting blade 36. As shown, the guides 31 have upper runs which are over and extend downward and forwardly to outer noses. The guides 31 also have lower runs which extend from the outer noses backwardly and downwardly to connect with the cutting head housing. Each individual guide is formed from a heavy wire of suitable material, such as steel, shaped as shown and described. The individual guides 31 are arranged so that the upper and lower runs are above and below one another, thus allowing the plants 30 to feed in between the guides 31 as they are approached by the cutting blade 36. The guides are positioned along the sides of the plants to provide lateral support which restrains the plants against lateral motion as the cutting blade 36 contacts the plants and forces the plants laterally. This arrangement allows better cutting.

Guides 31 also importantly serve as safety guards which prevent various foreign objects from being brought into contact with the cutting blade 36. Of prime importance is the added safety provided to the human operator 20 preventing him from placing hands or feet into contact with the blade 36. Similarly, safety guards 31 also prevent the cutter blade from contacting most dirt and rocks when laid upon the ground. Relatively large plants, such as saplings or brush stems also tend to be excluded by guards 31 to prevent overloading the cutter and causing damage thereto.

FIG. 3 also shows that the front part 11 of harvester 10 includes an intake port 40. As shown, intake port 40 is formed within the tubular cutting head housing 24. The intake port allows plant cuttings 41 to move inwardly after being cut from the remaining portions of the plants.

FIG. 3 also shows that the front part 11 includes a vacuum generator 50. Vacuum generator 50 is provided in the form of a rotary impeller 51 which rotates within an impeller housing 52. The impeller housing has an inlet port 53 which is in direct fluid communication with the intake port 40 so that the plant cuttings 41 can be drawn from the cutter 35 under the action of the vacuum generated by vacuum generator 50. Impeller 51 is rotated by an impeller driver 55. As shown, impeller driver 55 is advantageously an electric motor housed within a housing 56. The impeller motor has an output shaft 57 upon which the impeller is mounted. The output shaft 57 and impeller 51 rotate together at speeds which are dependent upon the desired amount of vacuum pressures being developed. In the preferred construction shown, the impeller angular velocity is also governed by additional considerations relating to the threshing function which is also performed by the impeller upon the plant cuttings as they are passed through the impeller and impeller housing. It should also be appreciated that the vacuum generator does not necessarily need to be in contact with the plant cuttings, although the configuration shown is of particular advantage in providing combined vacuum generation and threshing action simultaneously as the cuttings pass through the impeller and impeller housing.

The impeller engages the plant cuttings to perform as a thresher. The impeller in this capacity is best provided with impeller vanes 58 which can be made from or covered by resilient materials. For example, the impeller vanes shown are advantageously made using rubber belting material which is reinforced with fiber cords. This material is widely available and has been used for many years in the agricultural industry. Another possible approach is to use a coating over solid impeller blades using a rubber or rubber-like material which absorb some of the impact caused when the rapidly spinning impeller comes into contact with the plant parts.

The preferred resilient contact surfaces for the thresher impeller and vanes prevents undesirable cracking of the wheat seeds or other grains or seeds 60 being harvested as the plant product. Depending upon the specific mechanical properties of the plant product, the vanes or other thresher surfaces may or may not require specific surface hardness properties. It has been found that with wheat seeds as the plant product, and with impeller speeds of approximately 10,000-13,000 revolutions per minute (rpm) it is desirable to use impeller vanes which are made from the flexible belting explained above. Other resilient materials or coatings may also be satisfactory, depending upon the impeller speeds desired.

In the model shown, the vacuum generating function of the impeller suggests speeds in the range indicated above. If a supplemental vacuum generator is used then the thresher impeller speeds may be reduced if desired to minimize damage to the plant product being harvested. Impeller speeds in the range of 5,000-10,000 rpm are believed desirable for the combined vacuum generating and threshing function provided when the impeller 51 is mounted within the flow path of the plant cuttings. The rotational speed will also vary with the radius of the impeller vanes. Various radii can be used to optimize the dual thresher impact and vacuum function. Alternatively, these can be provided by separate mechanisms. It may also be acceptable to have a separate vacuum generator and use a thresher which operates at a slower or adjustable speed to allow better speed control and thresher performance.

FIG. 3 also shows that the front part 11 is further advantageously provided with a front part handle arrangement. The preferred front part handle arrangement includes an upper or first handle bar 54 and a second or extended handle 58. This handle arrangement allows for easy manual holding of the front part 11 during operation. Also shown is an operator control switch 96 which is used by the operator to control operation of the harvester.

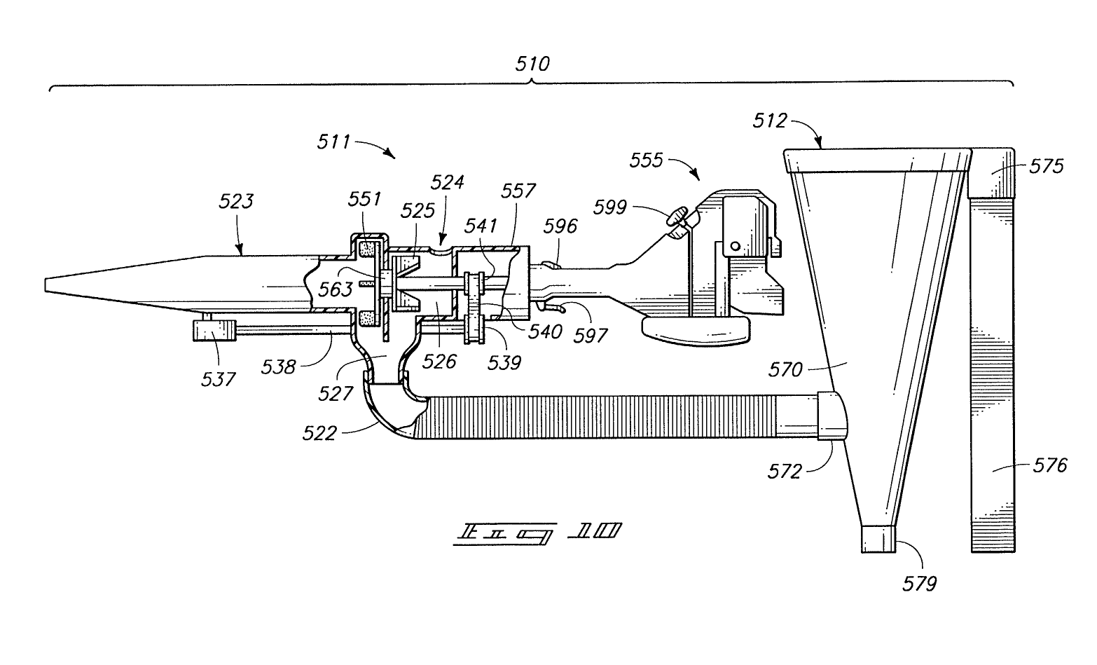

It should also be appreciated that the impeller 51 serves a further function as a plant cuttings conveyor. The impeller housing 52 includes a volute with outlet port 59. Outlet port 59 is connected to a cuttings conduit 22 which extends between the front and rear parts of the harvester. The cuttings conduit 22 preferably has a smooth interior surface to facilitate conveyance of the plant cuttings. In the configuration shown, the cuttings conduit 22 receives threshed plant cuttings which are being conveyed to the rear part of the harvester, more specifically to a separator 70. Alternatively, the plant cuttings conveyor can be wholly or partly performed by a separate conveyor which can be driven separately or from a common power source as the threshing impeller. One alternative construction is shown believe in connection with the fifth embodiment of FIGS. 9 and 10.

First Embodiment Rear Part

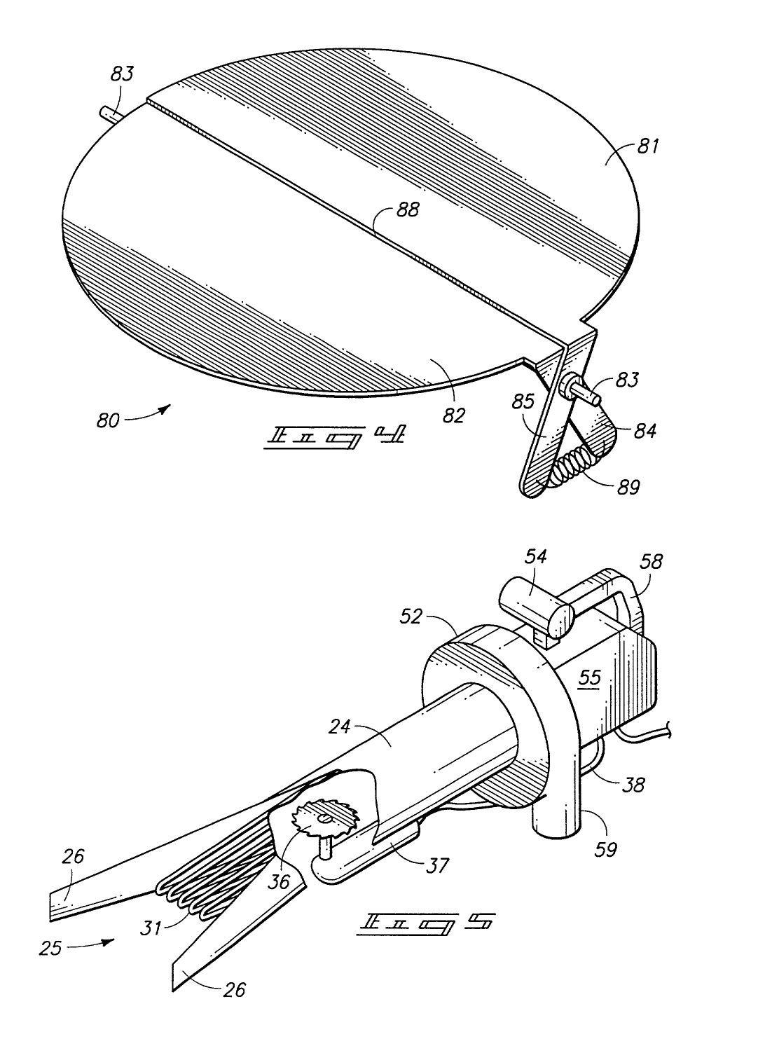

The rear part 12 preferably includes a separator 70 which is used to separate the threshed plant cuttings into plant product 60 and remnants 62 of the cuttings. The cuttings remnants in the case of wheat are straw stems and chaff. The separator 70 cyclonic air movement but the separator has been specially adapted for separating grains from chaff and stems. The separator receives the plant cuttings at a separator inlet port 72. The inlet port 72 is positioned intermediate between the top and bottom of the separator chamber 73, more preferably in the lower half of the separator. Separator chamber 73 is advantageously an inverted conical shape defined by the separator side wall. The inlet port brings the cuttings into the separator chamber at an approximately tangential trajectory which causes the conveyed cuttings and air to swirl about within the separation chamber. The relatively lighter straw and chaff swirl upwardly toward an upper outflow port 75 under the fluid dynamic forces applied by the moving air. The upper or remnant outlet is different from conventional cyclone separators because it is preferably located along the upper periphery of the separation chamber. Convention cyclone separators have outlets which are usually aligned along the centerline of the conical shape of the sidewall. The outlet is also made relatively large to allow the straw to freely pass outwardly without plugging. FIG. 2 shows that the separator outflow port 75 can be fitted with a downspout 76 or other suitable outfall line which preferably directs the flow downwardly. The downspout shown reduces the amount of dust to which the human operator 20 is exposed during operation of the harvester. The separator 70 also -has a product outlet 77 which is adjacent to a product receiver and collector 78. The product collector 78 is in part formed by lower portions of the separator sidewall. It also is preferably formed by a bottom wall which is advantageously provided in the form of a product discharge valve 80. FIG. 4 shows a preferred product discharge valve 80 in greater detail. Valve 80 includes a first and second valve parts 81 and 82. Since these valve parts are designed to work at the bottom of a circular product collector, they are provided with a circular outer peripheries. Other shapes are alternatively possible. The valve parts are pivotally mounted by pivot pins 83 which extend through apertures formed in side tabs 84 and 85 formed on each of the valve parts. The valve 80 is opened by manually squeezing the distal portions of tabs 84 and 85 together to pivot the valve parts and create a discharge opening between the abutting interior edges 88 of the valve parts. A spring 89 can advantageously be provided to bias the discharge valve into a closed condition to thereby retain plant product upon the discharge valve until the operator or his assistant (not shown) wish to empty the product collector 78.

FIG. 3 shows that the product discharge is preferably provided with a discharge chute 79. Discharge chute 79 is cylindrical or other suitable shape to facilitate the attachment or placement of a product storage bag 90 or other suitable product receptacle used to empty the product collector.

In one particular embodiment of the invention the separator 70 is built with the following specifications. The overall height is about 31 inches. The diameter of the discharge chute is about 3 inches. The diameter of the upper end of the separator chamber is about 13 inches. The angle of the sidewall is about 79° relative to the horizontal when upright. The inlet is about 3 inches in diameter. The outfall preferably has a rectangular or square opening which is larger in cross-sectional flow area than the inlet.

Second Embodiment Cutting Head

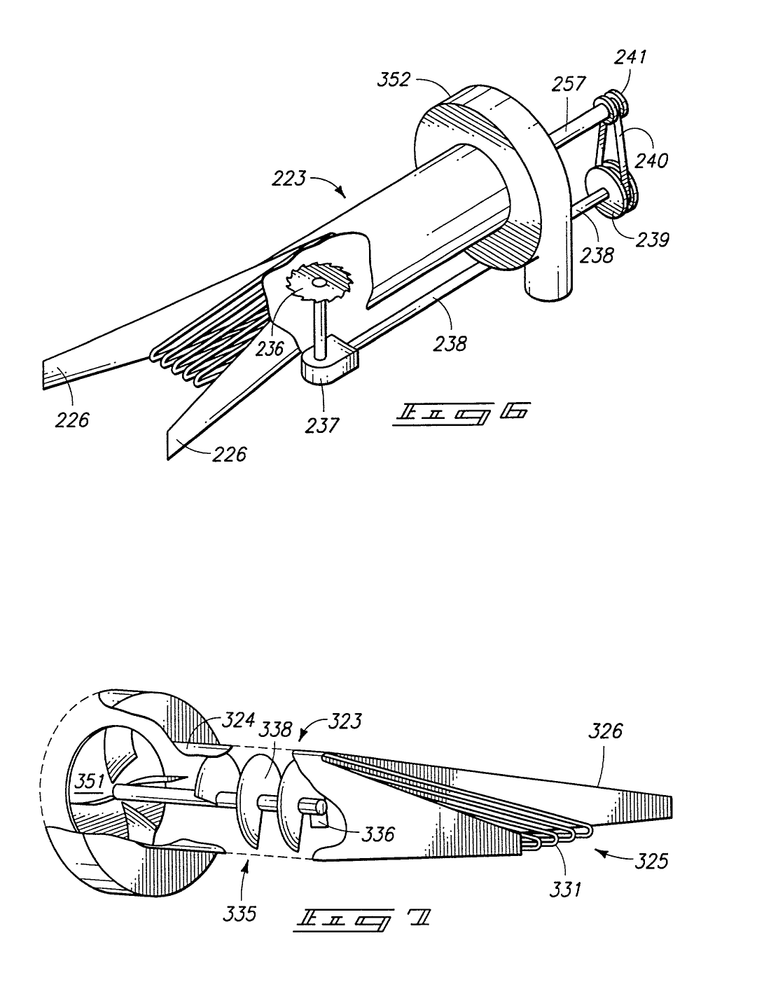

FIG. 6 shows an alternative second embodiment cutting head 223 which can be used in some forms of the invention. Cutting head 223 is similar to cutting head 23 except with regard to the manner in which the cutting blade 236 is powered. Similar features are numbered similar to the first embodiment with the addition of a “2” in the hundreds column; for example, blade 36 is 236 in FIG. 6.

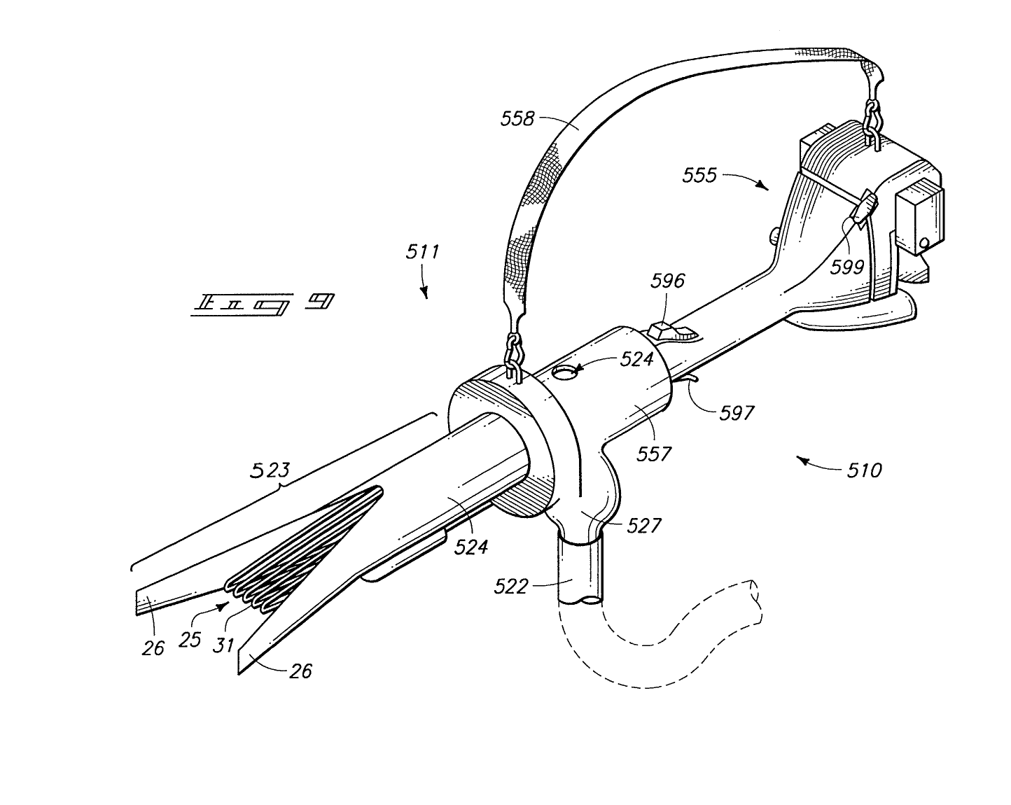

FIG. 6 shows that the cutting blade 236 is powered using a right angle gear box 237. The gear box 237 has an input shaft 238 which is driven using a pulley 239 and belt 240. Belt 240 is driven by a drive shaft pulley 241 mounted upon a motor output shaft 257. Shaft 257 can be powered by an electric motor, an internal combustion engine, or other prime mover (not shown). FIG. 8 shows an alternative embodiment which utilizes the construction shown in FIG. 6 with an internal combustion engine which will be described in greater detail below.

Third Embodiment Cutting Head

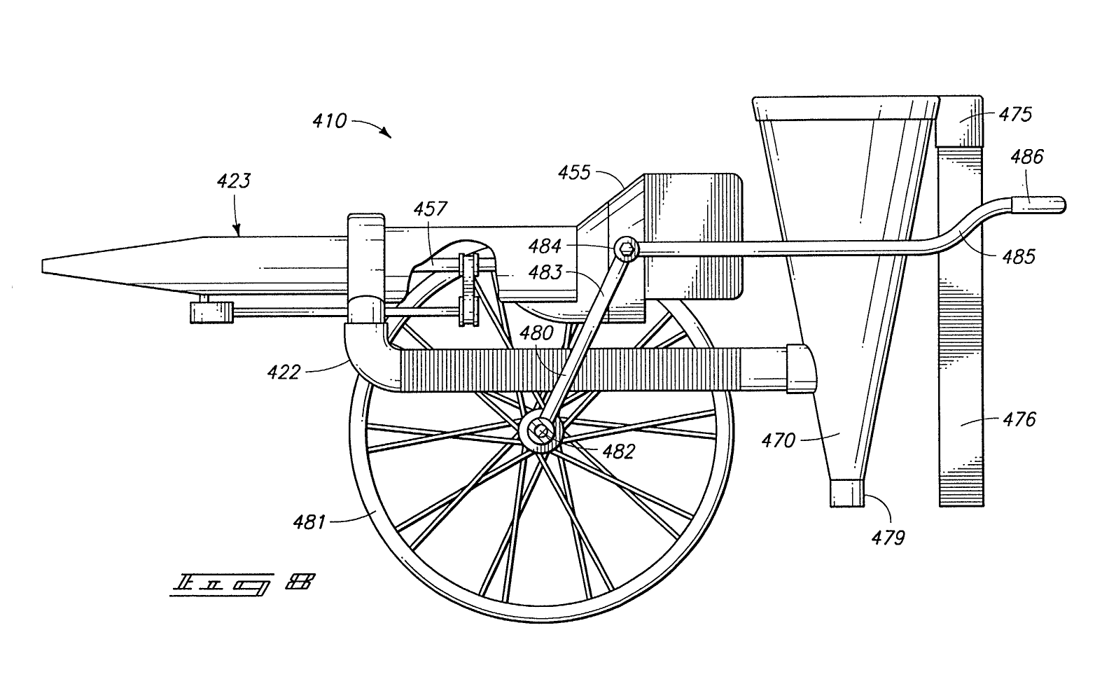

FIG. 7 shows a further and third embodiment cutting head 323 according to another version of the invention. Cutting head 323 has a feed opening 325 and guides 326 and 331 similar to those described above at 26 and 31. The cutting blade 26 has been replaced by a combined auger and cutter 335. The combined auger and cutter has a cutter in the form of a leading cutting edge 336 formed on the forward end of the auger 338. Auger 338 is rotated within the intake port of cutting head tube 324. The auger 338 is preferably mounted forward of the impeller 351 and upon the impeller shaft to rotate therewith. Alternatively, the auger 338 can be mounted upon a shaft carried within the impeller shaft and driven through a speed reducing gear set (not shown). The auger 338 aids in feeding the plant cuttings to the impeller 351. Impeller 351 functions as both a vacuum generator and thresher. It further functions to convey the threshed cuttings onwardly in a manner the same as described above.

Fourth Embodiment

FIG. 8 shows a further embodiment of single row harvester according to the invention. Harvester 410 is powered by an internal combustion engine 455 having fuel reservoir and parts as are well known in the art of lawn mowers, weed whackers, etc. The engine 455 has an output shaft 457 which mounts a pulley 441 similar to pulley 241 described in connection with FIG. 6. The cutting head 423 is similar to cutting head 223 described above and the description shall not be repeated. Threshed cuttings are conveyed through the cuttings conduit 422 to a separator 470 similar to separator 70 described above. Separator 470 has a product discharge 479 and downspout 476 similar to discharge 79 and downspout 76 of FIG. 3.

Harvester 410 differs in having a wheeled carriage 480 upon which the harvester can be transported. Carriage 480 includes a pair of wheels 481 which are mounted for rotation relative to remaining portions of the carriage upon an axle 482. Carriage member 483 extends upwardly from the axle 482 and connects with a suitable mount 484 which connects remaining parts of the harvester 410 to carriage 480. Mount 484 can advantageously be located so as to balance the harvester parts mounted thereon to thereby allow easy adjustment of the attitude of the harvester relative to the carriage.

The carriage 480 also includes a pair of handle bars 485 which handles 486 which are located at the distal ends thereof. Handles 486 can be held by a human operator (not shown in FIG. 8). Harvester 410 can be operated by a human operator who walks behind the wheel mounted unit with easy height adjustment by raising or lowering the handles 486. Carriage 480 can include additional structural members as desired for any particular application.

Fifth Embodiment

FIGS. 9 and 10 show a fifth embodiment harvester 510 according to the invention. FIG. 10 shows that harvester 510 includes a front part 511 and rear part 512. FIG. 9 shows that the harvester front part 511 can be provided with a carrying strap to ease operation and carrying for a human operator (not shown).

Harvester front part 511 has a cutting head 523 constructed as described above in connection with cutting heads 23 and 223. The similar components will not be described again and the parts have been numbered similar to those used above. Differences and noteworthy features will now be described.

The cutter (not shown in FIGS. 9 and 10) is powered using a gear box 537, shaft 538, pulley 539, belt 540 and pulley 541 similar to the construction shown and described in connection with FIG. 6. The shaft upon which pulley 541 is mounted is driven by a suitable motor 555, such as a 4-cycle gasoline internal combustion motor available from the manufacturer Ryobi and is commercially available on weed whackers. The motor has a starter pull cord handle 599, control switch 596 and safety lever 597.

The impeller 551 is provided with flexible belting vanes which engage the plant cutting to perform the threshing action. The impeller 551 also functions as a vacuum generator which generates a vacuum to draw the plant cuttings into the harvester after the cutter cuts the plants. The impeller in this model is driven through a speed reduction gear set 563 so that the impeller rotates at a different speed, such as a slower speed; for example, 2,000-5,000 rpm.

The output shaft from motor 555 is also connected to run a supplementary plant cuttings conveyor. The supplementary cuttings conveyor includes an impeller 525 which operates at a different speed, such as a faster speed, than the thresher impeller 551. The impeller 525 is mounted within a conveyor housing having an internal chamber 526 and an air intake port 524. Intake port 524 can be varied in size and provided with a screen (now shown) over or in the opening. Impeller 525 expels air into a combining output manifold 527 which feeds conveying air from impeller 525 and plant cuttings and associated air from impeller 551. This arrangement provides increased air flow to convey the cuttings better through the conduit 522 and into separator 570 through inlet port 572. It also provides added air for the cyclonic action of the separator without requiring all air to be conveyed through action of the thresher impeller 551. The separator is similar to those described above and has a product outlet 579 and remnants outlet 575 with associated downspout 576.

It is also possible to run the impellers 551 and 525 upon the same shaft and adjust the radii of the vanes to balance the amount of air provided by each. This also allows the speed of the thresher as implemented by impeller 551 to be varied without needing a gear set such as 563. Various combinations of gearing and impeller size can be used to enhance operation.

It should also be appreciated that the thresher and vacuum generator can be performed by or in part shared by multiple impellers in a fashion conceptually similar to impellers 551 and 525. These can be provided driven by the same shaft or using gearing. Alternatively, the vacuum generator and thresher can be completely separate and driven by different drives. Separate, supplemental vacuum generators and cutting conveyors can also be provided using the same drive shaft or a single drive shaft with one or more gear sets or other speed changers.

Methods

The invention further includes novel methods for harvesting plants, such as cereal grains or other seed bearing plants having useful plant products. The novel methods preferably involve harvesting a single row or single plant at a time. The methods include feeding plants into a feed opening of the harvester. The feeding can be done partly by having the human operator move the feed opening toward the plants to be cut and the guides 26 function to guide the plants into the feed opening. The feeding is also assisted by the guides 31 which help to support the plants after they are fed into the feed opening.

The feeding is advantageously performed into a cutting head having a cutter for severing the plants. The cutting or severing step can be accomplished by rotating a circular or other appropriately shaped cutter blade against the plants. The cutting is typically performed in such a manner as to cut the plant stems. The cutting results in producing plant cuttings which are severed from plant remains which stay in the field.

The novel methods further advantageously include vacuuming the plant cuttings into an intake port. The vacuuming is performing by generating a vacuum pressure and communicating the vacuum pressure to the intake port to assist in drawing the plant cuttings thereinto. This process is improved by placing the intake port adjacent to the cutting operation to better withdraw the cuttings after they are cut.

The novel methods also further preferably include threshing the plant cuttings to free plant product from remnant parts of the plant cuttings which are not desired. The threshing is advantageously performed by engaging the plant cuttings. This engaging can be performed by impelling the plant cuttings against a suitable thresher, such as by contacting the plant cuttings with a moving impeller. The threshing can be performed in a manner which includes rotating an impeller against which the plant cuttings are engaged and impelled. The threshing can be performed with vanes that contact the plant cuttings. The threshing can use resilient vanes or other thresher parts which can flex in response to impact with the cutting. This can resulting in action which involves impelling the cuttings with a flexible thresher part or parts. The threshing operation leaves a mixture of seeds or other plant product with the cutting remnants.

In still further preferred methods according to the invention, the threshing is preferably followed by a conveying step which conveys the threshed plant cuttings to a suitable end, such as to a separator. The conveying can be performed solely by the threshing impeller, or with a separate conveyor which adds some or all of the conveying air flow.

The plant cuttings are then conveyed from the threshing section to the separator. This is best performed by passing the cuttings through a smooth walled conduit to facilitate conveyance of the plant cuttings.

The novel methods still further can advantageously include separating the threshed plant cuttings. The separating segregates the plant product from remnants of the plant cuttings. The separating can be performed by introducing the threshed plant cuttings into a separator having a cyclonic air flow pattern, or other suitable separator. In the preferred cyclonic separator, the threshed plant cuttings are brought to the separator in a moving condition. The methods then involve introducing the cuttings in a tangential orientation into the cyclonic chamber at an elevation between the top and bottom, and more preferably in the lower part of the chamber. The methods also include swirling the threshed cuttings about the separation chamber under the force of the conveying air, or possibly some supplementing air flow used to enhance the separation process. The swirling action causes the lighter chaff and straw to swirl upwardly toward the remnant outflow and pass out of the separator and onto the ground. The separator also functions by allowing the heavier plant seeds or other plant product to swirl and drift or fall downwardly to the bottom.

The plant product is preferably collected by collecting the plant product in the lower reaches of the separator or in another suitable structure. The collecting can be done while packing the separator on the back or otherwise on a human operator. The cutting can also be performed by hand-held or otherwise carrying the front part of the harvester and rear part of the harvester. Alternatively, either of the harvester parts can be hand carried and the other part carried upon a carriage or other suitable structure. When one or both of the front and rear parts are carried on a carriage, they can preferably be moved by rolling the wheels of the carriage over the field in which the harvesting is being performed.

The harvesting can also be performed in such a manner that the human operator is moving the cutting head to direct the cutting operation and varying the cutting height as desired. The cutting can also be done by handling the harvester, including handling a wheeled carriage upon which the harvester is carried and which forms a part of the greater harvester.

The harvesting contemplated by this invention can further include producing electrical power by generating the electrical power at a location remote from the cutting operation. The remotely generated power is then utilized by transmitting the power, such as through power cord 101, to the harvester working in the field location. This remote generation of power can serve to more fully reduce the risks of fire by remotely positioning the generator outside of the field in which the test or developmental crop is being grown and harvested.

It should further be understood that additional methods and apparatuses similar to those described herein can be accomplished and built by combining the various steps and components shown and described herein in differing ways to accomplish similar functions and apparatuses which perform the indicated harvesting operations and the various aspects of each.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A harvesting machine for harvesting plants from a field a single row at a time, comprising:
a cutting head which has a feed opening through which plants enter the harvesting machine, the feed opening having a width which approximates a single row of plants;
guides adjacent to the feed opening to help guide portions of the plants into the feed opening;
a cutter for severing the plants to produce plant cuttings which are separated from plant remains which stay in the field;
a vacuum generator which generates a vacuum;
an intake port in communication to receive vacuum from the vacuum generator, said intake port being adjacent to the cutting head to remove plant cuttings through the intake port under force of the vacuum;
a thresher for threshing the plant cuttings to free a plant product from remnant parts of the plant cuttings;
a separator connected to receive plant cuttings from the thresher to separate the plant product from the remnant parts of the plant cuttings;
a product collector connected to receive and hold said plant product separated by the separator.

2. A harvesting machine according to claim 1 wherein the thresher includes an impeller which contacts the plant cuttings.

3. A harvesting machine according to claim 1 wherein the thresher includes an impeller which rotates and contacts the plant cuttings.

4. A harvesting machine according to claim 1 wherein the thresher includes an impeller which contacts the plant cuttings, and wherein the impeller also serves as at least part of the vacuum generator.

5. A harvesting machine according to claim 1 wherein:
the thresher includes an impeller which contacts the plant cuttings, and the impeller also serves as at least part of the vacuum generator;
the separator is a cyclonic separator connected to receive the plant cuttings contacted by the impeller.

6. A harvesting machine according to claim 1 wherein the thresher includes an impeller which contacts the plant cuttings, said impeller also serving as at least part of the vacuum generator, said impeller further serving as at least part of a cuttings conveyor for aiding in conveyance of the plant cuttings to the separator.

7. A harvesting machine according to claim 1 wherein:
the thresher includes an impeller which contacts the plant cuttings, said impeller also serving as at least part of the vacuum generator, said impeller further serving as at least part of a cuttings conveyor for conveying the plant cuttings to the separator;
the separator is a cyclonic separator connected to receive the plant cuttings contacted by the impeller.

8. A harvesting machine according to claim 1 wherein:
the thresher includes an impeller which contacts the plant cuttings, said impeller also serving as at least part of the vacuum generator, said impeller further serving as at least part of a cuttings conveyor for conveying the plant cuttings to the separator;
the separator is a cyclonic separator connected to receive the plant cuttings contacted by the impeller, said separator being mounted on a pack which can be carried by a person.

9. A harvesting machine according to claim 1 and further comprising a product discharge for discharging plant product held in the product collector.

10. A harvesting machine according to claim 1 and further comprising a product discharge for discharging plant product held in the product collector, said product discharge including a controllably discharge valve allowing the plant product to be controllably discharged from the product collector.

11. A harvesting machine according to claim 1 wherein the separator is mounted on a pack which can be carried by a person.

12. A harvesting machine according to claim 1 wherein the harvesting machine can be carried by a person.

13. A harvesting machine according to claim 1 wherein the cutting head is adapted to be carried by hands of a human operator and the separator is mounted on a pack which can be carried by the human operator.

14. A harvesting machine according to claim 1 and further comprising a wheeled carriage upon which the harvesting machine can be transported over the field.

15. A harvesting machine according to claim 1 wherein said guides include side guides.

16. A harvesting machine according to claim 1 wherein said guides include cutter guides which support the plants being cut by the cutter.

17. A harvesting machine according to claim 1 wherein said cutter is on an auger mounted for rotation to facilitate intake of plant cuttings.

18. A harvesting machine for harvesting plants from a field, comprising:
a cutting head which has a feed opening through which plants enter the harvesting machine;
a cutter mounted upon the cutting head for severing the plants to produce plant cuttings which are separated from plant remains which stay in the field;
an impeller which is mounted upon the cutting head for rotational movement, said impeller serving to generate a vacuum which aids in removal of plant cuttings from the cutter; said impeller also engaging the plant cuttings to thresh the plant cuttings and free a plant product from remnant parts of the plant cuttings.

19. A harvesting machine according to claim 18 and further comprising a separator connected to receive the plant cuttings from the impeller, said separator functioning to separate the plant product from the remnant parts of the plant cuttings.

20. A harvesting machine according to claim 18 and further comprising a separator connected to receive the plant cuttings from the impeller, said separator functioning to separate the plant product from the remnant parts of the plant cuttings;
and wherein the impeller further functions as at least part of a cuttings conveyor for aiding in conveyance of the plant cuttings to the separator.

21. A harvesting machine according to claim 18 and further comprising:
a separator connected to receive the plant cuttings from the impeller, said separator functioning to separate the plant product from the remnant parts of the plant cuttings;
a product collector connected to receive and hold said plant product separated by the separator.

22. A harvesting machine according to claim 18 and further comprising a separator connected to receive the plant cuttings from the impeller, said separator functioning to separate the plant product from the remnant parts of the plant cuttings, and wherein the separator is mounted on a pack which can be carried by a person.

23. A harvesting machine according to claim 18 wherein the harvesting machine can be carried by a person.

24. A harvesting machine according to claim 18 wherein the cutting head is adapted to be carried by a human operator and the separator is mounted on a pack which can be carried by a person.

25. A harvesting machine according to claim 18 and further comprising a wheeled carriage upon which the harvesting machine can be transported over the field.

26. A harvesting machine according to claim 18 wherein said cutter is on an auger mounted for rotation to facilitate intake of plant cuttings.

27. A harvesting machine for harvesting plants from a field, comprising:
a vacuum generator which generates a vacuum;
a hand-held front harvester unit which includes a cutting head which has a feed opening through which plants enter the harvesting machine, and a cutter for severing the plants to produce plant cuttings which are separated from plant remains which stay in the field; said front harvester unit further including an intake port in communication to receive vacuum from the vacuum generator, said intake port being adjacent to the cutting head to remove plant cuttings through the intake port under the action of the vacuum;
a thresher for engaging the plant cuttings to free a plant product from remnant parts of the plant cuttings;
a rear harvester unit which includes a separator connected to receive plant cuttings from the thresher to separate the plant product from the remnant parts of the plant cuttings, and a product collector connected to receive and hold said plant product separated by the separator.

28. A harvesting machine according to claim 27 and further defined by a said vacuum generator and said thresher being at least partially provided in the form of an impeller which generates a vacuum and engages the plant cuttings to perform a threshing operation.

29. A harvesting system for harvesting plants from a field a single row at a time, comprising:
a field subsystem having:
a cutting head which has a feed opening through which plants enter the harvesting machine, the feed opening having a width which approximates a single row of plants;
a cutter for severing the plants to produce plant cuttings which are separated from plant remains which stay in the field;
a vacuum generator which generates a vacuum;
an intake port in communication to receive vacuum from the vacuum generator, said intake port being adjacent to the cutting head to remove plant cuttings through the intake port under the action of the vacuum;
a thresher for engaging the plant cuttings to free a plant product from remnant parts of the plant cuttings;
at least one electrical motor used to power the cutter, the vacuum generator, and the thresher;
a separator connected to receive plant cuttings from the thresher to separate the plant product from the remnant parts of the plant cuttings;
a product collector connected to receive and hold said plant product separated by the separator;
a remote power generator for generating and communicating electrical power to the field subsystem.

30. A harvesting machine which is manually propelled for harvesting plants from a field a single row at a time, comprising:
a carriage;
at least one wheel mounted for rotation upon the carriage for contacting the field to allow the harvesting machine to be manually propelled over the field;
at least one handle connected to the carriage for allowing a person to manually engage the harvesting machine to propel the harvesting machine over the field and along a row being harvested;
a cutting head which has a feed opening through which plants enter the harvesting machine, the feed opening having a width which approximates a single row of plants;
guides adjacent to the feed opening to help guide portions of the plants into the feed opening;
a cutter for severing the plants to produce plant cuttings which are separated from plant remains which stay in the field;
a vacuum generator which generates a vacuum;
an intake port in communication to receive vacuum from the vacuum generator, said intake port being adjacent to the cutting head to remove plant cuttings through the intake port under the action of the vacuum;
a thresher for threshing the plant cuttings to free a plant product from remnant parts of the plant cuttings;
a separator connected to receive plant cuttings from the thresher to separate the plant product from the remnant parts of the plant cuttings;
a product collector connected to receive and hold said plant product separated by the separator.

31. A method for harvesting plants from a field a single row at a time, comprising:
feeding plants into a feed opening of a cutting head;
cutting the plants by severing the stems of the plants to produce plant cuttings which are severed from plant remains which remain in the field;
vacuuming the plant cuttings into an intake port;
threshing the plant cutting to free a plant product from remnant parts of the plant cuttings.

32. A method according to claim 31 and further comprising separating the plant product from the remnant parts of the plant cuttings.

33. A method according to claim 31 wherein said vacuuming and said threshing are at least partially performed by an impeller which rotates and engages the plant cuttings.
